(19) United States
(12) Patent Application Publication
(10) Pub. No.: US 2005/0003704 A1
(43) Pub. Date: Jan. 6, 2005

(54) Leg part for fixing connector to printed board

(76) Inventor: Masayuki Kasahara, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/863,364

(22) Filed: Jun. 9, 2004

(30) Foreign Application Priority Data
Jun. 11, 2003 (JP) 2003-166279

(51) Int. Cl. H01R 13/60

(52) U.S. Cl. 439/567

(57) ABSTRACT

To prevent from fitting into an insertion part of the other leg part or from being deformed on packing and, additionally to strengthen a fixation by soldering, a leg part for fling a connector to a printed board has an elongated hole, and a protrusion or bulging part is provided in long side parts of the elongated hole so that a narrowest space in the elongated hole becomes narrower than a plate thickness of the leg part. The shape of the protrusion or bulging part is formed into a rectangular shape, a triangular shape, a trapezoid shape, a semicircular shape, a semi-elliptic shape, or a combination of two or more among the same shapes.

### BACKGROUND OF THE INVENTION

1. Field of the Invention

The present invention relates to a leg part for fixing or connecting a connector or a shield member and the like to a printed board by soldering, especially relates to a leg part adapted so as to prevent one leg part from fitting into and becoming entangled in an insertion part of the other leg part when the leg parts are packed respectively as a single piece or when the shield members each of which has the leg part are packed, and to strengthen a fixation by soldering.

2. Related Art

In prior arts, when mounting the connectors, shields for coping with an EMI, or electronic components to a printed board, the soldering is performed by inserting the metal-made leg part monolithically provided, for example, in the connector into an attaching hole provided in a predetermined position of the printed board and flowing it to a soldering dip tank.

For example, there is known one in which the leg part extends downward from one part of a case of a metal-made power source unit, and the leg part is soldered by being inserted into the attaching hole of the printed board (JP-A-8-149798).

For example, as shown in FIG. 5A and FIG. 5B, in a case where a leg part 12 formed in a shield 11 for coping with the EMI is soldered by being inserted into an attaching hole 13a of a printed board 13, a through-hole 12a is provided in a plate thickness direction.

The trough-hole 12a is one for reducing a weight and acting as a hole for allowing a deformation of the leg part when the leg part is inserted into the attaching hole 13a. Further, it is one for improving also a solder adhesion force by the fact that a solder enters into the through-hole 12a. However, since the through-hole 12a exists, if the leg parts are packed in a bag without being individually partitioned, there is the fact that one leg part 12 fits into the through-hole 12a of the other leg part 12, and becomes entangled.

Further, in case of press fitting the leg part 12 to an insulation housing of the connector or the like by a presser as the single piece, or in case of insert-molding it to the connector or the like by mounting to a metal die, there is the fact that the leg part under a state mutually entangled intact when taken out of the bag is deformed and, further, the component cannot be supplied normally. In this case, the mutually entangled leg parts must be separated by a manual work one by one, so that it becomes a troublesome work. The leg part for fixing connector to printed board according to the invention is proposed in order to solve such problems.

### SUMMARY OF THE INVENTION

In order to solve the above problems, a leg part for fixing a connector to a printed board according to the invention, being formed in a plate-like shape and having an insertion part to be inserted into an attaching hole of a printed board and the insertion part having a though-hole provided in thickness direction, wherein the through-hole is formed in an elongated hole, and a protrusion or bulging part is provided in long side parts of the elongated hole so that a narrowest space in the elongated hole becomes narrower than a plate thickness of the leg part.

The shape of the protrusion or bulging part may be a rectangular shape, a triangular shape, a trapezoid shape, a semicircular shape, a semi-elliptic shape, and one or a combination of two or more among the same shapes.

The protrusion or bulging part may be provided only in one side between the opposed both long side parts.

According to the leg part for fixing connector to printed board of the invention, the protrusion or bulging part is provided in the elongated hole of the insertion part, and accordingly even if the leg parts are packed in the bag respectively as the single piece or as one part of a member and the leg part attempts to enter into the elongated hole, it is prevented by the protrusion, so that there is no fear that the leg parts are mutually entangled and no deformation occurs. Further, if the leg part is inserted into the attaching hole of the printed board and soldered, a space of the elongated hole becomes narrow in a portion of the protrusion or bulging part and an adhesion of the solder becomes good, so that an attaching strength is improved.

### BRIEF DESCRIPTION OF THE DRAWING

FIG. 1A is a front view of a leg part for fixing connector to printed board according to the invention, and FIG. 1B is a side view of the same;

FIGS. 2A to 2F are partial front views of embodiments showing various shapes of a protrusion or bulging part provided in an elongated hole of the leg part for fixing connector to printed board according to the invention;

FIG. 3A is a plan view showing a used state of the leg part for fixing connector to printed board according to the invention;

FIG. 3B is a sectional view of the same;

FIG. 4A is a perspective view showing a state that, even in a case where the leg parts for fixing connector to printed board according to the invention are packed in a bag for instance, they don't become entangled each other; and FIG. 4B is a sectional view showing a state mounted to a printed board by soldering; and

FIG. 5A is a perspective view showing a used state of the leg part according to a conventional example and FIG. 5B is sectional view showing a state the leg part being inserted into a through hole of a printed board.

### DETAILED DESCRIPTION OF PREFERRED EMBODIMENT

Next, a leg part 1 for fixing connector to printed board (hereinafter, referred to merely as leg part) according to the invention is explained by referring to the drawings. Incidentally, in order to facilitate an understanding of the invention, the explanation is made with the same reference numeral as the conventional example being affixed to a portion corresponding to the conventional example.

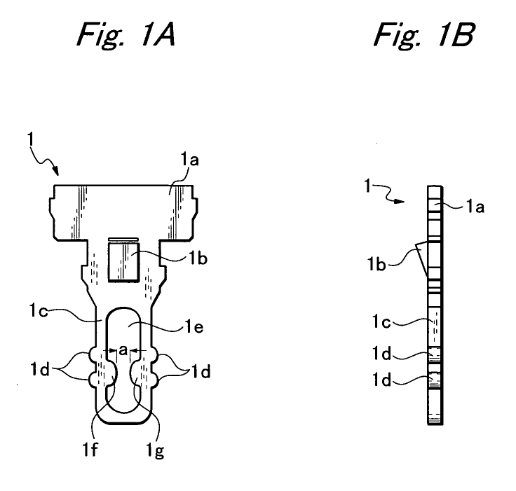

As shown in FIGS. 1A and 1B, the leg part 1 is a single piece press-fitted or inserted into a fitting part of a synthetic-resin-made housing of a connector or the like, for instance. It has an upper fitting part 1a, an engaging protrusion 1b in a case of being press-fitted, a lower insertion part 1c to be inserted into a hole of a printed board, mounting protrusions 1d provided outside the insertion part 1c, and an elongated hole 1e which is punched in a plate thickness direction and long in a vertical direction.

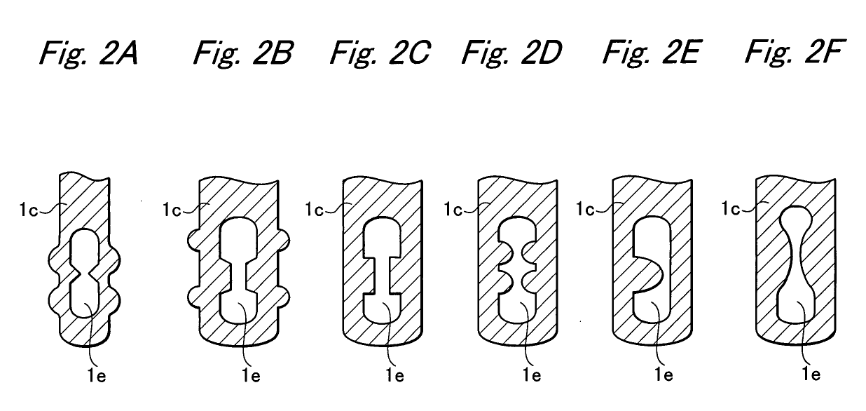

As shown in FIG. 1A, the elongated hole 1e is provided with protrusions 1f, 1g in long side parts of the elongated hole 1e. These protrusions 1f, 1g are protruded so as to mutually approach while being faced each other. A shape of the protrusion or bulging part is made a semicircular shape in the drawing but not limited to this and, as shown in FIG. 2A to FIG. 2F, it may be made in a rectangular shape (FIG. 2C), a triangular shape (FIG. 2A), a trapezoid shape (FIG. 2B), a semi-elliptic shape (not shown in the drawing), additionally one (FIG. 2E) or a combination (FIG. 2D) of two or more among those shapes, and in addition a bulging part (FIG. 2F) bulged by a gently curved line.

As shown in FIG. 1A, as to an approaching manner of the protrusions 1f, 1g, it is a condition that a space “a” is narrower than a plate thickness of the leg part 1. This is to prevent from fitting of the insertion part 1c of the other leg part into the elongated hole 1e.

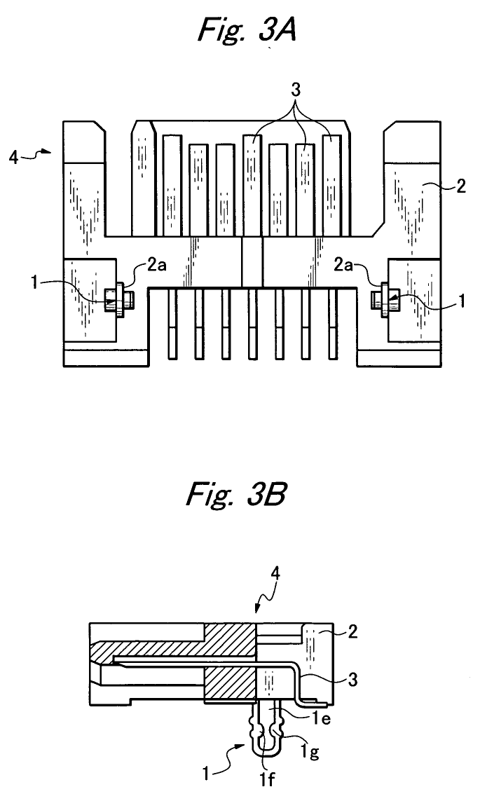

FIGS. 3A and 3B show a plug connector 4 in which the leg part 1 is fitted into each of fitting holes 2a of a synthetic-resin-made insulation housing 2 while pressure-inserting plural contacts 3 into the insulation housing 2.

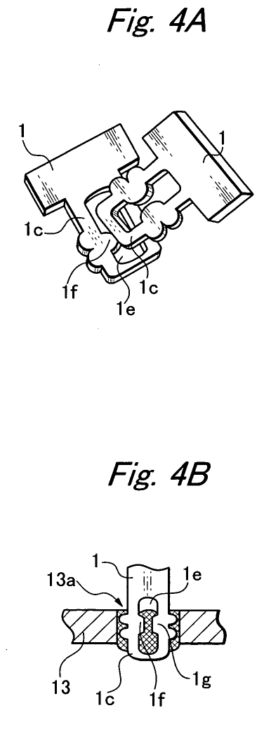

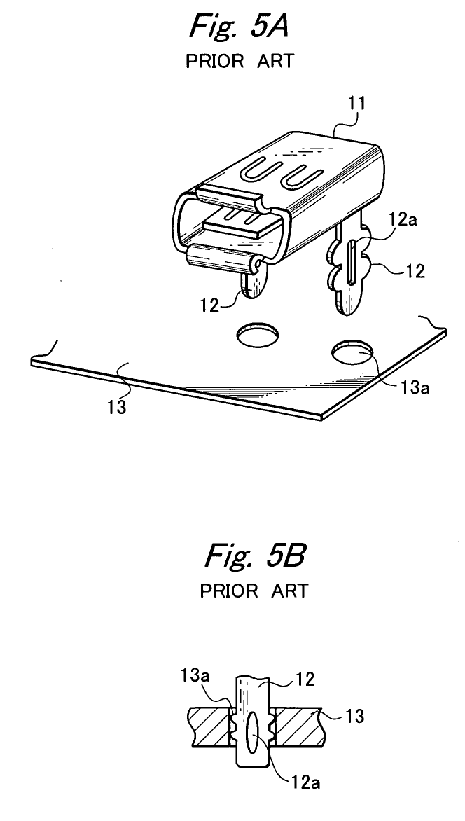

Under a state that the leg parts 1 are packed in the bag as the components before being fitted into the insulation housing 2, even if they contact so as to become complicatedly entangled as shown in FIG. 4A, the insertion part 1c of the other leg part 1 never fit into the elongated hole 1e due to the existence of the protrusions 1f, 1g in the elongated hole 1e. Therefore, it becomes easy to take out the leg part 1 of the single piece from a packing material such as bag. Further, also in the leg parts 1 press-fitted into the plug connector 4, they don't become entangled each other, and also the deformation is difficult to occur.

Incidentally, also in a case where the leg part 1 is formed as one part of the shield member or the like and many shield members are packed similarly in a box, the insertion part 1c of the other shield member is prevented from fitting into the elongated hole 1e of the leg part 1 and never become entangled, so that the deformation is difficult to occur as well.

After having been monolithically formed as the leg part for attaching the printed board of the plug connector 4, as shown in FIG. 4B, if the insertion part 1c of the leg part 1 is inserted into the attaching hole 13a of the printed board 13 and soldered in the dip tank, since a length of an edge in the elongated hole 1e is longer than the conventional one, as a result, a solder adhesion area becomes larger, so that a fixing strength is improved. Further, when a diameter of the attaching hole 13a of the printed board 13 is small, the protrusions 1f, 1g mutually butt at the time of insertion, thus the protrusions have a function to prevent an excessive deformation of the elongated hole 1e.

1. A leg part for fixing a connector to a printed board, being formed in a plate-like shape and having an insertion part to be inserted into an attaching hole of the printed board and the insertion part having a though-hole provided in thickness direction,
wherein the through-hole is formed in an elongated hole, and a protrusion or bulging part is provided in long side parts of the elongated hole so that a narrowest space in the elongated hole becomes narrower than a plate thickness of the leg part.

2. A leg part according to claim 1, wherein a shape of the protrusion or bulging part is a rectangular shape, a triangular shape, a trapezoid shape, a semicircular shape, a semi-elliptic shape, and one or a combination of two or more among the same shapes.

3. A leg part according to claim 1, wherein the protrusion or bulging part is provided only in one side between the opposed both long side parts.

4. A leg part according to claim 2, wherein the protrusion or bulging part is provided only in one side between the opposed both long side parts.
